(19) United States
(12) Patent Application Publication
(10) Pub. No.: US 2002/0100884 A1
(43) Pub. Date: Aug. 1, 2002

(54) Digital 3-D model production method and apparatus

(76) Inventor: Brian L.W. Maddock, Brampton (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/052,561

(22) Filed: Jan. 23, 2002

Related U.S. Application Data
(60) Provisional application No. 60/264,295, filed on Jan. 29, 2001.

(51) Int. Cl. G01V 8/00; G01N 21/86

(52) U.S. Cl. 250/559.29

(57) ABSTRACT

Preferably, the spatial coordinates of a surface are determined by an optical method comprising scanning the surface with an incident beam of light from a scanner head, determining the range to the surface at a plurality of points on the surface relative to the scanner head by a means of a return beam reflected from the surface, determining the relative spatial location and orientation of the scanner head at the time of scanning each of said plurality of surface points by a remote optical sensing system that includes a plurality of positioning sensors each located at a different known location relative to the other positioning sensors and a plurality of markers attached to the scanner head, with each marker at a at different location relative to the other markers. Preferably, the colours of a target surface are measured together with the surface spatial coordinates by an optical method comprising the scanning of the surface with an incident beam of laser light from an optical parametric oscillator tuned so that the beam contains at least one well defined wavelength, determining the spatial coordinates of the surface at a plurality of points by means of a return beam reflected from the surface, measuring the intensity of the reflected laser light at each of said points on the surface, tuning the optical parametric oscillator to a plurality of different discrete wavelengths and repeating the measurements of surface spatial coordinates and reflectance intensities for each of these new wavelengths, and combining the reflectance intensities measured at these different wavelengths at each surface point into a multi-channel composite that expresses the coloration of the surface.

This application claims the benefit under 35 USC 119 of U.S. Provisional Pat. App. Ser. No. 60/264,295 filed Jan. 29, 2001.

### SCOPE OF THE INVENTION

This invention relates to methods and apparatus for creating digital 3 -D models.

### BACKGROUND OF THE INVENTION

Tools for building digital 3 -D models are known that permit the measurement of the geometric shape of an object by measuring the relative location of points on the object's surface and utilizing various computer programs to develop a computerized three-dimensional representation of the object. Historical measurement systems began with manual measurement of the relative location at various points. Subsequently, sensor systems such as touch probes were used to determine the location of points by bringing the probe's endpoint into physical contact with the surface of an object. Other non-contact sensors useful as surface coordinate measurement tools include laser spot sensors that use optical triangulation or time of flight measurement of a laser beam to establish the range from the sensor to a surface point. Laser stripe sensors, preferred for much higher rates of data acquisition and ease of maintenance, are used to collect data points along an entire line profile on an object's surface. Sweeping spot sensors are another variation in which a laser spot sweeps across an object's surface dynamically, measuring a line profile as a succession of points.

Various scanner location systems have been used in conjunction with surface measurement sensors. In some systems, a sensor such as a laser spot sensor or a laser stripe sensor may be fixed in position as it shines onto an object while the object is moved on a motion platform beneath the scanner as its position is accurately tracked relative to the laser sensor. Sensors, such as laser stripe sensors, are known to be mounted on various gantry-type Coordinate Measuring Machines (herein called CMMs) that permit control over one, two or three positioning axes and sometimes one or two orientation axes.

Another type of CMM takes the form of a robotic armature upon whose endpoint the laser scanner is mounted. The robotic arm tracks the position of the laser sensor as it is moved around an object during the surface scanning process. Such robotic arms can provide up to six axes of movement (three for position, three for orientation) and typically can provide increased reach and flexibility for positioning the laser scanner when compared to gantry systems. The relative movement of the robotic arm is used to measure the position of the laser sensor. With its base fixed in place, a robotic armature CMM provides a common coordinate reference frame for all surface coordinates collected by the laser scanner. Some mechanical extension arms and rail motion systems have been integrated with CMMs to extend the range of the robotic arm's reach by allowing the base to be repositioned. This additional step requires a re-calibration of each new base position to ensure that all laser scanner surface coordinates are collected in a common reference frame.

Robotic arm CMM systems have also been used to position a contact probe instead of a laser scanner. Some of these systems have also been integrated with optical means for base-position re-calibration. At the first CMM base location, surface measurements are made with the touch probe throughout the CMM's reach envelope. The CMM base is then repositioned to a second location and the new base location is calibrated in the reference frame of the first by using optical triangulation with infra-red light. Another set of surface measurements is then made throughout the new reach envelope, relative to the second base location. The CMM is subsequently moved to successive base positions, depending on the volume of space through which coordinate measurements are required. These systems have the disadvantage that base-position calibration takes time and must be repeated several times for large objects. They also continue to depend on CMM robotic armatures for coordinate data collection, constraining the reach for each new base position by the length of the arm.

Known systems that provide the capability of capturing surface colour data from an object and mapping it onto the digital 3 D model provide very limited colour accuracy and limited spatial colour detail within the data. Typically, existing systems use a digital camera integrated with a 3 D laser scanner to capture surface colour data and subsequently superimpose it onto the digital 3 D model of the surface-scanned object. With these systems, the process of mapping the colour data onto the model surfaces can give rise to spatial distortions of the colour data. Furthermore, these systems require surface illumination from external or integrated lighting to minimize shadowing distortions of the colour arising from ambient light effects. Even then, the supplied lighting will inevitably cause lighting distortions to the surface colouration.

Known technologies for 3 D surface colour imaging include the use of three differently coloured laser diodes, each emitting a discrete wavelength of light, one red, one green and one blue (hereafter called RGB). These coloured lasers are spatially multiplexed to simultaneously illuminate the surface of the object during the process of measuring surface topography. While the reflected laser light is triangulated to measure the spatial coordinates of each surface point, the reflectance intensity is also measured for each laser, that is, for each of the colours red, green and blue, after separating the reflected light into its three component colours. The composite reflectance data for the red, green and blue laser diodes provide a measure of surface colouration that approximates the object's real-life colours. The disadvantage of this system is that it provides only a low precision colour representation. Colour is defined as the intensity of light reflected from a surface for all wavelengths throughout the entire visible spectral band. The more discrete wavelengths for which the reflectance intensity is measured, the greater will be the precision of the measured colour. The RGB laser diode system is limited in its colour precision in that it provides only three intensity channels. Also, the commercially available selection of differently coloured laser diodes is quite limited, thereby constraining the potential for increasing the colour precision of this system.

### SUMMARY OF THE INVENTION

To overcome some of these disadvantages of previously known surface measurement devices, the present invention provides a combination of a surface measuring laser sensor with a remote positioning system. The remote positioning system allows the position and orientation of a laser scanning sensor to be dynamically measured with an accuracy comparable to that of the position data provided by robotic armature CMMs. The positioning system utilizes a plurality of reference points of known relative locations to triangulate within a large active volume using electromagnetic radiation, such as infra-red light, to determine the position and orientation of a laser scanner sensor-head within that volume. This remote positioning system reduces the need for any mechanical positioning device to determine the location of the surface-scanning sensor. Preferably, robotic armature and gantry systems for tracking the location of the sensor can be eliminated, allowing the sensor to be hand-held and freely moved without mechanical constraint throughout a large active volume monitored by the remote positioning system.

The surface-scanning sensor is preferably a laser stripe sensor, although other surface sensor types can be used. When coupled with the remote positioning system, the sensor can be hand-held and moved freely by the operator anywhere within an active volume defined by motion tracking sensors of the remote positioning system, in order to collect 3 D surface measurements. The sensor will preferably have a cable connection to a power source and a data display/recording device, although it could have its own independent “on-board” power source and provide for local storage and/or remote transmission of its collected data.

One goal of the present invention is to provide an improved system and method for making 3 D surface measurements.

Another goal is to provide a method and apparatus for making 3 D surface measurements that permits accurate measurements from the surfaces of relatively large objects.

A further goal of the present invention is to provide a method and apparatus for making 3 D surface measurements without requiring a mechanical positioning device either to move the laser scanning sensor or to dynamically track the position of either the laser scanning sensor or the object or environment it is scanning.

To overcome at least some of the disadvantages of known surface colour imaging technologies, the present invention utilizes laser light at a wide variety of discrete wavelengths to provide a more accurate determination of the colour of a surface by determining the reflectance intensity at each of those wavelengths and combining the intensities into a multi-channel composite representation of the surface colour. For each selected wavelength, the set of reflectance intensities for the measured surface is associated with the 3 D surface geometry points that are also collected by the laser scanning process. Since the spatial coordinate reference frame remains fixed throughout multiple scan passes over the surface, with one pass for each discrete wavelength, all intensity measurements, defining the coloration of the surface, are automatically mapped to the surface geometry data.

The present invention uses a device that can produce multiple discrete wavelengths of coherent light, with operator control over the selection of each specific wavelength, where the selections can span the full range of the visible spectrum. In accordance with the present invention, the preferred device for the laser light source is a visible light Optical Parametric Oscillator (OPO), which can produce laser light of any selected discrete wavelength from the visible light spectrum, as well as the near ultra-violet and near to mid infra-red spectrum. In accordance with the present invention, the OPO laser light source replaces the more typical singlewavelength laser diode used in the laser scanner optics as the light source for illuminating an object's surface during 3 D scanning. With the OPO tuned to a specific wavelength, the intensity of the reflected light is measured across the entire surface of the object being scanned. The OPO is then tuned to another discrete wavelength and the process is repeated, accumulating a second set of reflectance intensities for the surface. The process can be repeated for as many wavelengths as desired. With reflectance intensity measurements being taken at a potentially large number of wavelengths, a much more precise measure can be obtained for the coloration of the surface.

The present invention also allows for the possibility of multiplexing several OPOs in parallel, so that their separate wavelengths, combined into a single beam, can simultaneously impinge on the surface for multiple-wavelength reflectance intensity measurements (the multiple-wavelength reflected light is subsequently divided into discrete wavelength beams for intensity measurement using wavelengthseparation optics). Multiplexing several OPOs will significantly increase the speed of colour data collection, although scanning with a single wavelength during each scan pass over the surface is sufficient to produce this invention's high precision colour measurement. In accordance with this invention, another means of increasing the speed of colour data collection is to time-multiplex several discrete wavelengths of light to measure their individual reflectance intensities within the time step of a single scan pass.

Since colour capture in accordance with the present invention collects a unique reflectance intensity measurement at the same time that it measures the 3 D geometric coordinates of a point on the scanned surface, the spatial resolution of the resulting surface colour data is the same as the spatial resolution of the surface geometry. This spatial resolution is much higher than can be obtained by methods of 3 D surface colour data capture that rely on digital colour cameras. Thus, in accordance with the present invention, the use of an OPO laser source allows the acquisition of colour data with very high colour accuracy and very high spatial resolution. In accordance with the present invention, the resulting colour representations are more realistic than those produced by known systems.

An object of the present invention is to provide improved determination of the colour of a 3 D surface.

In one aspect, the present invention provides an optical method of determining the profile of the target surface comprising:

(a) scanning the surface with an incident beam of light from a scanner head,

(b) determining the range to the surface at a plurality of points on the surface relative to the scanner head by means of a return beam reflected from the surface,

(c) determining the relative spatial location and orientation of the scanner head at the time of scanning each of said plurality of surface points by a remote optical sensing system that includes a plurality of positioning sensors each located at a different known location relative to the other positioning sensors and a plurality of markers attached to the scanner head, with each marker at a different location relative to the other markers.

In another aspect, the present invention provides an optical method of determining the spatial coordinates and colour of a target surface comprising:

(a) scanning the surface with an incident beam of laser light from an optical parametric oscillator tuned so that the beam contains at least one well defined wavelength,

(b) determining the spatial coordinates of the surface at a plurality of points on the surface by means of a return beam reflected from the surface;

(c) measuring the intensity of the reflected laser light at the one selected well defined wavelength at each of said points on the surface;

(d) repeating steps (a) to (c) a plurality of times with the optical parametric oscillator tuned so that the beam has a different discrete wavelength (i.e. at least one well defined) each of the plurality of times,

(e) determining the colour at each surface point by combining into a multi-channel composite the reflectance intensities measured for each of the discrete wavelengths of laser light selected through tuning of the optical parametric oscillator.

### BRIEF DESCRIPTION OF THE DRAWINGS

Further aspects and advantages of the present invention will become apparent from the following description, taken together with the accompanying drawings, in which:

FIG. 1 is a schematic pictorial view of a large environment scanning system in accordance with the present invention.

FIG. 2 is a schematic pictorial view of a preferred laser scanner optical head.

FIG. 3 is a schematic pictorial view of a true colour scanning system in accordance with the present invention.

### DESCRIPTION OF THE DRAWINGS

Reference is made to FIG. 1, which schematically shows a preferred embodiment in accordance with the present invention. An active scanning volume is demarcated by floor space 10, with a plurality of support platforms 12 at the periphery of this floor space. Each of these support platforms 12 carries a remote positioning sensor indicated by item numbers 14, 15 16 and 17. An automobile is show as an object 18 whose surface is to be measured. A surface-scanning laser sensor 20 is shown being held in the hand of a human operator 22. The surface sensor 20 is shown coupled by a flexible power and data cable 24 to a controller 26. The controller 26 provides power to the surface sensor 20 via a power cable, shown as the combined power and data cable 24. The communications link between the controller 26 and the surface sensor 20 is provided by a data cable, again shown as the combined power and data cable 24. This power and data cable 24, linking the surface sensor 20 with its controller 26, may be as long as desired, limited only be the need to avoid power and/or data degradation with increasing cable length.

In use, the operator 22 can move about the object 18 and manually position the surface sensor 20 anywhere around the object 18 to scan its surfaces and collect 3 D coordinate data or colour data. The surface sensor 20 can be held by an operator in front, behind, to each side, above and below the object 18. As well, the surface sensor may be placed inside the object 18, as for example inside the interior of the automobile or between a wheel and the wheel cavity of the automobile, limited of course by the requirement that a sufficient subset of the remote positioning system sensors (represented by 14 to 17) have an unimpeded “line of sight” to the surface sensor 20 for accurate determination of the surface sensor's position and orientation.

The controller 26 is mounted on a wheeled platform 27, allowing it to move about as it follows the surface sensor 20, while the latter is moved anywhere within the active volume above floor area 10.

While the preferred embodiment shows the power and data cable 24 connecting the surface sensor 20 to the controller 26, such a cable is not necessary if the surface sensor 20 has an independent power supply and independent means for storing collected data therein, and/or may remotely communicate with other devices such as the controller. The power supply for the surface sensor may be a battery and may be carried by the operator 22 in the manner of a backpack or belt attachment.

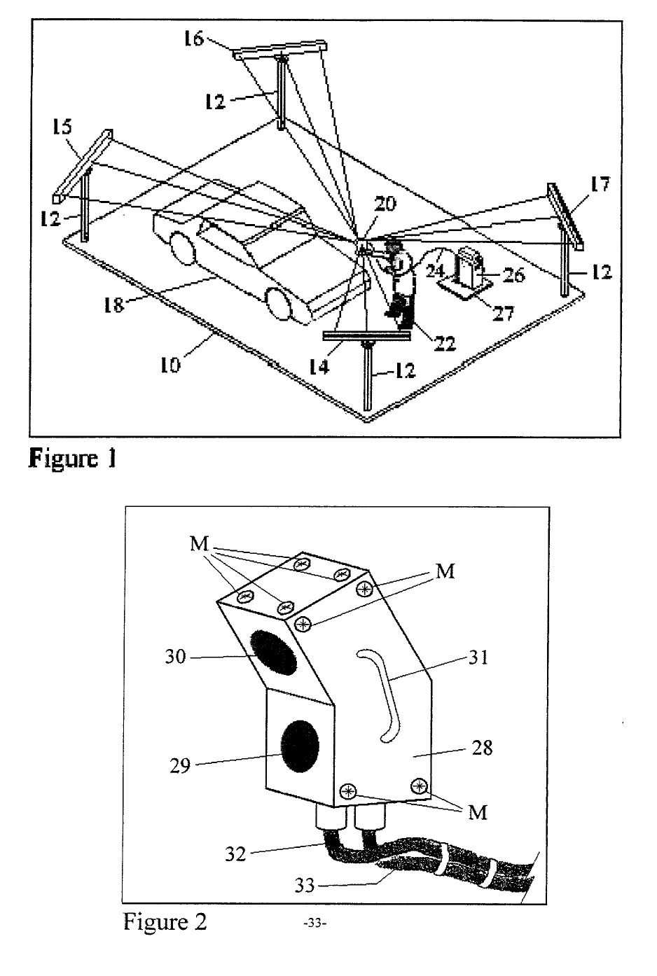

The position tracking system utilizes multiple positioning sensors, represented by 14, 15, 16 and 17 (although not limited to four), to determine the relative location of the surface sensor 20 at any time within the active volume above and demarcated by floor area 10. In this regard, the surface sensor 20 preferably has a plurality of individual reference points on its housing to facilitate determination of its location and orientation. FIG. 2 schematically illustrates the surface-scanning laser sensor 20. It is shown to have a physical housing 28 that encloses the scanner optical elements, a laser light source (typically a laser diode) and a detector for measuring the laser light reflected from an object's surface. An aperture 29 is provided for the laser light emitted from the enclosed light source and a second aperture 30 for capture of surface-reflected laser light by the enclosed detector, which is typically a Charge-Coupled Device (CCD) array, i.e. of a digital camera (linear or matrix, depending upon the type of laser scanner). A handle 31 is provided for an operator to hold the surface-scanning laser sensor, and a data communications cable 32 and power cable 33 (together referred to as item 24 in FIG. 1) link the sensor 20 to its controller 26.

Reflective or active (light emitting) markers, designated ‘M’, are attached at various locations on the scanner housing 28, serving as reference points detected by the remote position tracking sensors, represented by 14, 15, 16 and 17 in FIG. 1. Active markers will preferably be infra-red LEDs (Light Emitting Diodes). In the embodiment shown, the markers M are affixed to each of the surfaces of the scanner housing 28. Several markers are also affixed to the housing surfaces not visible from the illustrated perspective. During each time step for real-time measurement, each active marker M is activated in sequence to emit infra-red light that is then detected by those remote position tracking sensors that have a “line of sight” to the marker in question. Activating the markers in a particular sequence during each time step allows each marker to be uniquely identified by the position tracking system. Once a marker M has been detected by a remote position tracking sensor, where the set of position tracking sensors is represented by 14, 15, 16 and 17 in FIG. 1, known methods of optical triangulation between sensors are used to establish the position of the marker. When the positions of three or more markers M have been measured, known methods of rigid-body analysis are employed to determine the orientation of the surface sensor 20 and the position for a “base-line” point within the sensor housing 28 that is used by the surface sensor 20 during its own surface coordinate measurement process. This “base” position and orientation for the surface sensor 20 is updated with new measurements by the infra-red motion tracking system during each time step of the data acquisition process. Present computer processing speeds permit such dynamic real-time updating by the infra-red motion tracking system. During each time step, the base position coordinates of the surface sensor 20 are combined with the surface sensor's own measurement of relative position coordinates on the surface of the scanned object 18 to provide object surface coordinates in a reference frame that is common to all such measurements made within the active volume above floor area 10.

Use of an optical system for establishing the scanner head position and orientation frees the laser scanner to be hand-held without the physical constraint of any attached mechanical positioning device. This allows the scanner to be moved through a much larger active scanning volume than if it were attached to a robotic armature or a rail-motion gantry system. It also allows scanning in confined spaces that would not be reachable by any scanning system attached to a bulky mechanical positioning system, thereby creating the possibility for application of this invention for material structural integrity testing, an engineering discipline known as Non-Destructive Evaluation (NDE). While the surface sensor 20 preferably utilizes visible light for scanning surfaces of an object, UV or infra-red light could provide useful information on the integrity of objects such as pressure vessels, water and steam pipes. In further pursuit of this application, a high-frequency ultra-sound probe could be interfaced to the remote position tracking system in place of the surface sensor 20, to permit three-dimensional imaging of sub-surface detail.

Initial set-up of the system involves accurate location of the remote position tracking sensors 14, 15, 16 and 17, which can be accomplished by established calibration methods. In practice, the positions and orientations of these remote position sensors, as well as the number of such sensors, can and will vary.

With multiple remote position tracking sensors working together, the system can accomplish position and orientation measurement of the surface-scanning laser sensor 20 anywhere within a large measurement volume. With each position tracking sensor, measurement of spatial coordinates by known methods of optical triangulation has associated measurement errors that increase with distance from the position sensor. In accordance with the present invention, the measurement accuracy of the position tracking system is refined by accounting for the overlap in measurement volume between successive position tracking sensors. When the tracked object, surface sensor 20, is moving away from one position tracking sensor, with a corresponding increase in measurement error, it will often be moving towards another sensor, for which the measurement error will be decreasing. With the present invention, this situation is exploited by calibrating the entire measurement volume, demarcated by floor area 10, so as to “cap” the measurement errors so they do not exceed a particular threshold. By limiting this drift in localization errors associated with multiple position tracking sensors, the overall measurement accuracy can be harmonized to make measurement errors less variable with distance from a given position sensor. As a result, the overall measurement accuracy of the system that uses a plurality of position sensors surrounding the active measurement volume can provide better accuracy than can be achieved from a single 3 D triangulation baseline. Such accuracy improvements allow the position tracking system, when integrated with a laser scanner, to provide consistent base referencing of the surface-scanning laser sensor 20, which requires a relatively constant level of base-position error for consistent surface data measurement. Although position measurement outside of the volume above floor area 10 is possible, provided infra-red markers on the tracked object 20 are visible to at least three position tracking sensors, the resulting position measurement for any location outside the active volume may have errors exceeding the error “cap” determined by the error harmonization process.

Preferably, in accordance with the present invention, the large environment scanning system would provide a feedback mechanism whereby an indication would be provided if the surface sensor 20 is moved to a location where the base position measurement error exceeds the error “cap”. In like manner, the position tracking system preferably would provide a feedback mechanism to indicate whether the position and orientation of the surface sensor 20 obstructs a direct line of sight to a sufficient number of active markers M on the sensor housing 28, thereby preventing measurement of the base position and orientation of surface sensor 20.

In accordance with the present invention, a software driver will be integrated with the scanner software to transmit the position tracker output data into the laser scanning system. This data will provide the base reference position for the scanner's own surface data measurements during each time step. The data transmission is to be accomplished in real-time, with receipt of the data synchronized to the scanner's own internal clock. A real-time data link between the position tracker and the scanner preferably will utilize a SCSI (Small Computer System Interface) data interface to ensure sufficient transmission speed and bandwidth. In accordance with the present invention, to ensure the scanner has an updated set of base position coordinates available as it begins the measurement of surface range data during each time step, the scanner software receives a “cue” to proceed only after each base position update has been determined by the position tracking system.

Although the discussion above assumes the application of infra-red light by the remote position tracking system to determine the base location and orientation of the surface-scanning laser sensor 20, the present invention is not limited to using only infra-red light for this purpose, nor to using a position tracking system that applies methods of optical triangulation during its measurement process. Using infrared light, it is necessary to ensure a direct line of sight to the surface sensor 20 from each of at least three remote position tracking sensors, represented by 14 to 17, in order to measure the location and orientation of the surface sensor. If however other electromagnetic frequencies are used by the position tracking system that do not require a direct line of sight, that is frequencies that can pass right through any obstructing body, then provided such electromagnetic frequencies can offer dynamic measurements of an object's position with sufficient accuracy, a position tracking system based on this electromagnetic radiation could be applied in the context of the present invention. Similarly, if the position tracking system applies established time of flight methods rather than optical triangulation methods to measure an object's position and orientation, and can also achieve that measurement with accuracy comparable to systems that use optical triangulation, then such a position tracking system could also be applied in the context of the present invention.

Since the nature and the number of position tracking sensors can be selected as desired, 3 D surface measurements can be accomplished within a volume of arbitrarily large size.

The surface-scanning laser sensor 20 is preferably a laser stripe type sensor, although it may also be a laser spot sensor or even a sweeping spot type sensor. Laser stripe sensors provide fast data acquisition rates since an entire line profile, consisting typically of 500 or more data points, is collected during each time step. With fraction of a second cycle times, a laser stripe sensor system can typically collect many thousands of data points per second.

On the other hand, a laser spot sensor provides a much lower rate of data acquisition, as it provides only a single data point per time step. Although sweeping spot sensors, as with laser stripe sensors, can provide hundreds of data points per time step, they have an added complication in that they accumulate a line of data points in succession, with each point acquired at a different time. Hence the time step for surface sensor position determination must be further sub-divided into smaller cycle times for individual surface data point acquisition. The most significant advantage of integrating a sweeping spot sensor with a remote position tracking system will be realized if the sweeping spot sensor sweeps the laser spot through two orthogonal directions during each time step of the position tracking system, thereby sweeping out an area rather than just a line. By sweeping out an area on the object's surface during each time step of the position tracking system, another order of magnitude increase in data acquisition rates can be realized, since, in a given time step, as many lines of points can be acquired (typically) as there are points in a line. The drawback of sweeping spot sensors is that they require mechanically-driven mirrors to deflect the laser spot as it sweeps across an object's surface and the mechanical components significantly increase the time required for system calibration, the incidence of needed repeat calibrations, and the overall costs for system maintenance. Laser strip sensors, on the other hand, use elliptical lenses to spread a laser spot into a line on the object's surface, eliminating the need for moving parts in the optical assembly, thereby minimizing re-calibration requirements and maintenance costs. For these reasons, a laser stripe sensor is anticipated in the preferred embodiment of the present invention.

Examples of applications for which the large environment scanning invention is useful include scanning of large manufactured objects such as aircraft and military vehicles; accident scenes for use in forensic reconstruction analysis and courtroom litigation support; archeological site reconstruction for scientific recordkeeping, excavation planning and analysis; stage set or film location 3 D imaging for film production planning; scanning of building facades for civil engineering analysis, conservation planning and three-dimensional architectural database construction.

3 D laser scanning with a true colour capture capability based on use of an Optical Parametric Oscillator (OPO) device as the source of the laser light allows wavelength selection through a broad spectrum, as an OPO can be tuned to any discrete wavelength throughout its tunable range. In accordance with the present invention, the surface-scanning laser sensor 20 preferably has a fiber optic input feed from an OPO laser source with a tunability range covering the entire visible light spectrum.

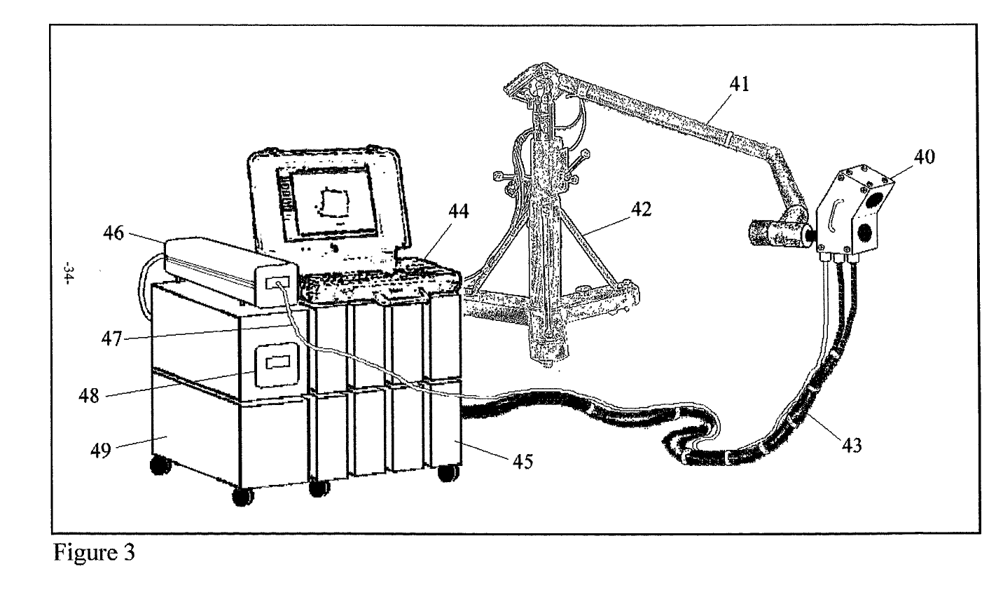

Reference is made to FIG. 3, which schematically shows a preferred embodiment in accordance with the present invention. The surface-scanning laser sensor 40 is shown attached to a robotic armature 41 mounted on a tripod support platform 42. The robotic armature provides base location coordinates for the sensor 40. As discussed earlier, in accordance with the large environment scanning invention, this robotic armature could be replaced by a remote infra-red position tracking system. The power and data communications cables would preferably run along the length of the robotic arm to keep them out of the way during the scanning process. The power and communications cables are shown in this configuration (attached to the robot arm) as well as being shown separate from the arm as item 43, which would be the configuration of the cables if an infra-red positioning system is used in place of a robotic armature for surface sensor base location determination.

The computer controller 44 for the surface sensor is mounted on a wheeled cart that also encloses the power source and additional support electronics 45. In accordance with the true colour scanning invention, an OPO device 46 is shown connected to the surface-scanning sensor 40 by means of an optical fiber bundle 47. A pump laser 48 feeds discrete wavelength ultra-violet input laser light into the OPO optics 46, where the beam is converted to an operator-tunable wavelength of visible or near to mid infra-red light. Because a human operator works with the laser scanner in close proximity, eye safety is a critical factor during its operation. To ensure no risk to human eyesight, the source laser light from the pump laser 48 is set at a power level that is low enough to meet government eye safety standards. The OPO output beam is used subsequently as the laser light source for the surface-scanning sensor 40. The controller for the OPO is shown as item 49.

When reflected light is captured from the surface of an object using ‘n’various discrete wavelengths of light selected by the system operator via the tunable OPO (preferably spanning the full extent of the visible spectrum), the resulting reflectance intensities, ‘I(1)’ to ‘I(n)’ for the ‘n’ applied wavelengths, are associated with the spatial coordinates also measured for each surface point by the laser scanner 40. Each measured surface point then consists of the following data: {X, Y, Z, I(1), I(2), 1(3), . . . , I(n)}, where X, Y and Z are the three spatial coordinates for the point. The more wavelengths for which intensity data is collected, the greater will be the spectroscopic accuracy of the colour representation. Scanning to collect intensity data at additional wavelengths will therefore increase the colour accuracy.

In one embodiment of the present invention, each surface reflectance intensity data set I(i) for a given wavelength of input laser light is collected during a separate scan pass over the surface of the object. Since manually sweeping the laser over the surface can result in some areas of the surface being scanned more than once during the same scan pass, these areas of overlap will have a plurality of redundant data points, each of which will have an associated intensity measure. Known methods for integrating redundant surface geometry data are applied by the system to automatically resolve these redundancies. This ensures that each geometry point in the final data set is unique and has an associated unique intensity measurement. Successive scan passes with different wavelengths also cover the same surfaces, resulting in inter-scan redundancies in the spatial geometry data. The same methods used to resolve intra-scan geometry data redundancies are applied to resolve interscan redundancies. This is possible because the positioning system, whether a robotic armature or a remote infra-red position tracking system, provides a spatial reference frame that is common to all data collection, whether the data is collected during a single scan pass or during multiple passes. Each of the intensity measures I(i) captured during successive scans of the same surface is uniquely registered to the uniquely resolved spatial data point (X(i), Y(i), Z(i)) during this “inter-scan registration” process.

The present invention preferably uses an optical fiber bundle 47 to carry the laser light into the scanner optical head 40, where it serves as the laser light source for the scanning process, replacing the laser diode (integrated into the optical head) currently used as the scanning light source. Optical fibers have light carrying properties allowing them to transmit light within a specific wavelength band. Since few, if any, optical fibers have material characteristics that cover the entire visible light spectrum, a bundle of fibers with overlapping wavelength bands will preferably be provided to transmit light from the OPO, substantially covering its entire active range. Optical switching can be used to select a specific fiber from the bundle with properties relevant for transmitting each wavelength of laser light produced by the OPO. In the event subsequent optical fiber research leads to the development of a single fiber capable of transmitting light of any visible wavelength, then the fiber bundle 47 could be replaced by this single fiber.

In another embodiment of the present invention, a number of wavelengths may be simultaneously applied in a single scan. This will be accomplished through one of two methods, involving spatial multiplexing in one case and time multiplexing in the other. The first method involves running several OPOs in parallel, each tuned to a different wavelength, and combining these OPO output beams into a single input beam for the laser scanner during the surface scan, to be subsequently divided into separate-wavelength beams after reflection from the object surface. Multiple detectors then measure these separate reflectance intensities, one detector for each wavelength. The second method entails stepping the laser output from a single OPO through several wavelengths during each time step of the base position tracking system, allowing each wavelength in succession to provide a reflectance intensity measurement recorded by the same detector.

The colour data produced by this invention will not have any of the shadowing or lighting distortions that plague most methods of colour imaging that rely on ambient or external source lighting for surface illumination during the data collection process. The laser light used to collect the colour data is itself also the source of surface illumination, which allows the data capture process to be accomplished even in a dark environment. Typically, the intensity of the laser light will exceed the intensity of any other light sources in the scan environment. Only if the ambient light impinging on the object's surface rivals the intensity of the laser light, as for example might happen under intense direct sunlight, will the laser scanner's detector possibly measure anomalous reflectance intensities. In practice these operating conditions will be avoided.

Laser stripe scanners are designed to collect surface range data only when the laser stripe is focused on the surface of the object. If the laser stripe is unfocussed, the system will typically reject the detected image of the reflected laser stripe as too broad in cross section and therefore having too much uncertainty for accurate range measurement. Preferably the system will provide feedback to the operator indicating when the scanner is within the optimum range to ensure a sufficiently focused laser stripe for data collection to proceed. With a red laser diode as the laser source, typical of existing 3 D laser scanners, the focal distance remains fixed for the system during all scanning operations. However, if an OPO is used as the laser source, the focal length will vary with the selected wavelength. To accommodate this focal length variability without major modifications to the optical assembly within the scanner, the present invention allows for the use of a micro-positioning table integrated into the scanner for real-time adjustment of the scanner optical elements to ensure a focused laser stripe regardless of the selected wavelength of incident light. Pre-calibration of the micro-positioning table can be carried out to allow automatic focal length adjustment during system use.

When a laser stripe is imaged by the scanner's integrated detector, it is recognized by the scanner software as a line profile within the background pixels of the image collected on the detector array. Any image pixel whose intensity exceeds a pre-set intensity threshold is considered to be a pixel belonging to the laser stripe profile. This intensity threshold for laser light detection is an element of existing laser scanner software. In accordance with the present invention, the scanner software is to be provided with criteria for recognizing the pixels belonging to the laser stripe profile when the wavelength of the laser light is changed, since the detector's sensitivity varies with wavelength. The detector's variable sensitivity leads to a requirement for a variable intensity threshold for strip profile recognition, depending on the wavelength of the incident light. Preferably these criteria for varying the intensity threshold will be provided through incorporation of a software routine into the scanner's software system to allow the automatic adjustment of the threshold as the wavelength is varied. Preferably these criteria will take the form of a look-up table identifying the relevant threshold for each wavelength throughout the visible spectrum based on a pre-calibration of the system, thereby allowing automatic adjustment of the threshold during routine scanner operation.

Since the number of wavelengths used to measure reflectance intensities is variable, the size of the data record for each point will also be variable in length. In accordance with the present invention, a new custom storage file format will be provided to accommodate this new source of information about an object's surface. Also in accordance with the present invention, a software routine will be integrated with the scanner's software system to allow real-time accumulation of the reflectance intensity for each data point. Typically, existing scanner systems measure the reflectance intensities in order to localize the laser stripe profile on the detector image to support range measurement for the data point by optical triangulation, but the measured intensities are not recorded. The new software routine will ensure the recording of these intensities and will also provide an interface with the system's spatial redundancy handling routine, as discussed earlier, to ensure that each intensity measurement is associated with a unique spatial data point.

Industry-supported standard 3 D data file formats already exist for digital 3 D model display and manipulation on a computer. The standard file formats that support the representation of 3 D surface coloration require data points with three spatial coordinates and three intensity measurements, (X, Y, Z, I(1), I(2), I(3)). Computer display screen phosphors have only a limited range for the representation of colours. Real-life colours identifiable by the human eye cover a much broader range. The true colour data produced by the present invention, covering this broader range, can be converted into one or more of the industry standard file formats. In accordance with the present invention, an off-line software utility will allow operator selection of three intensity data ‘channels’ from the set of ‘n’measured intensities and incorporate them into a standard-format file coupled with the spatial coordinates of each data point measured by the laser scanner. Since none of the commercial software programs for digital 3 D model display and manipulation can presently read true colour data (that is, more than three intensity channels), this new file, adhering to industry standards, will offer a convenient means of data conversion for use by these other commercial systems.

In accordance with the present invention, the system will preferably provide operator control over and/or feedback on the status of (i) the micro-positioning of scanner head optics, both for routine use and during the micropositioning calibration process, (ii) laser light transmission into the scanner optics by optical switching between fibers within the fiber bundle 47, (iii) intensity threshold selection for stripe profile recognition for any selected wavelength, with operator control provided for both routine use and for the intensity threshold calibration process, and (iv) setting of control parameters needed to resolve spatial data redundancies.

In accordance with the present invention, the following are provided in a preferred embodiment of a true colour scanner:

1. implementation of an interface between a 3 D laser scanner and an optical parametric oscillator used as a laser light source;

2. real-time software for laser stripe profile recognition based on intensity threshold adjustment calibrated to wavelength variation;

3. real-time software to record laser light intensity data in each data record along with spatial position coordinates;

4. real-time software for multi-wavelength intensity data recording in variable length data records;

5. focal length adjustment by micro-positioning control of scanner optics;

6. off-line software for standard format colour texture map generation based on operator selection of intensity channels from the multi-wavelength data files; and

7. a graphic user interface program for operator control over the true colour data capture and system calibrations.

In accordance with the present invention, the following are provided in a preferred embodiment of a large environment scanner: implementation of an interface between a 3 D laser scanner and an infra-red position tracking system to replace the scanner's mechanical positioning device;

2. real-time software for multi-position-sensor accuracy refinement and harmonization for measuring the base coordinates of the laser scanner optical head using the position tracking system;

3. modification of the position tracker's real-time data acquisition software to allow this accuracy refinement during each time step while measuring scanner base coordinates;

4. real-time software for cuing of the surface scanning process using position tracker data and transmission of each base position update from the position tracker to the scanner during each time step.

While the invention has been described with reference to a preferred embodiment, many modifications and variations will occur to persons skilled in the art. For a definition of the invention, reference is made to the following claims:

I claim:

1. An optical method of digitally measuring the spatial coordinates of a target surface, where the method comprises:
(a) scanning the surface with an incident beam of light from a scanner head,
(b) determining the range to the surface at a plurality of points on the surface relative to the scanner head by means of a return beam reflected from the surface,
(c) determining the relative spatial location and orientation of the scanner head at the time of scanning each of said plurality of surface points by a remote optical sensing system that includes a plurality of positioning sensors each located at a different known location relative to the other positioning sensors and a plurality of markers attached to the scanner head, with each marker at a different location relative to the other markers.

2. An optical method of determining the spatial coordinates and colour of a target surface, where the method comprises:
(a) scanning the surface with an incident beam of laser light from an optical parametric oscillator tuned so that the beam contains at least one well defined wavelength,
(b) determining the spatial coordinates of the surface at a plurality of points on the surface by means of a return beam reflected from the surface;
(c) measuring the intensity of the reflected laser light at the one selected well defined wavelength at each of said points on the surface;
(d) repeating steps (a) to (c) a plurality of times with the optical parametric oscillator tuned so that the beam has a different discrete wavelength (i.e. at least one well defined) each of the plurality of times,
(e) determining the colour at each surface point by combining into a multi-channel composite the reflectance intensities measured for each of the discrete wavelengths of laser light selected through tuning of the optical parametric oscillator.
